(19) United States
(12) Patent Application Publication
(10) Pub. No.: US 2007/0212909 A1
(43) Pub. Date: Sep. 13, 2007

(54) Valve connector of air pump

(76) Inventor: Lo-Pin Wang, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/400,805

(22) Filed: Apr. 10, 2006

(30) Foreign Application Priority Data
Mar. 7, 2006 (TW) 95107662

(51) Int. Cl. H01R 13/62

(52) U.S. Cl. 439/157

(57) ABSTRACT

A valve connector of an air pump includes a case, two connector assemblies, a pressing member and a lever. The case has a channel therein. The connector assemblies, each of which has an elastic barrel, are received in the case and communicated with the channel. The pressing member has a bottom and two arms projected from the bottom, between which the case is received. The bottom has two bores associated with the elastic barrels of the connector assembly. The lever is pivoted on the pressing member between the arms by a pin. The lever is moved to move the case proximal or distal to the bottom of the pressing member so as to compress or loose the elastic barrels.

### BACKGROUND OF THE INVENTION

1. Field of the Invention

The present invention relates generally to an air pump, and more particularly to a valve connector of the air pump.

2. Description of the Related Art

FIG. 1 shows a conventional valve connector of an air pump, which includes a case 10, in which a main member 18 and two connectors 14 and 15 are provided, a level 27 and a pin 28 provided on the case 10. Aforesaid valve connector is a double-channel valve connector. Compare to the single-channel valve connector, aforesaid double-channel valve connector has two connectors and an auto-switching assembly. The valve connector has the connectors 14 and 15 squeezed into a bottom of the case 10 prior to the main member 18. As a result, the size requirement of the connectors 14 and 15 is very high. If the rubber connectors 14 and 15 had slightly greater sizes, the connectors 14 and 15 have problem to be squeezed into the bottom of the case 10. In addition, when lifting the lever 27 to move the main member 18 relative to the case 10, it has to overcome the friction between the main member 18, a sealing ring 33 above the main member 18 and the case 10. It needs more power to move the lever 27

### SUMMARY OF THE INVENTION

The primary objective of the present invention is to provide valve connector of an air pump, which has an easier way of assembly.

The secondary objective of the present invention is to provide valve connector of an air pump, which need less power to move the lever.

According to the objectives of the present invention, a valve connector of an air pump includes a case, at least a connector assembly, a pressing member and a lever. The case has a channel therein. The connector assembly is provided in the case and communicated with the channel. The connector assembly includes an elastic barrel. The pressing member has a bottom and two arms projected from the bottom, between which the case is received. The bottom has a bore associated with the elastic barrel of the connector assembly. The lever is pivoted on the pressing member between the arms by a pin, which has a first cam portion and a second cam potion. A distance between the first cam portion and the pin is less than that between the second cam portion and the pin. The elastic barrel is loosed when the lever is moved with the first cam portion pressing the case to move the case distal to the bottom of the pressing member, and the elastic barrel is compressed when the lever is moved with the second cam portion pressing the case to move the case proximal to the bottom of the pressing member.

### BRIEF DESCRIPTION OF THE DRAWINGS

FIG. 1 is a sectional view of the conventional valve connector;

FIG. 2 is a front view of a preferred embodiment of the present invention;

FIG. 3 is a bottom view of the preferred embodiment of the present invention;

FIG. 4 is a sectional view along A-A line of FIG. 3;

FIG. 5 is a sectional view along B-B line of FIG. 3; and

FIG. 6 is a sectional view of the preferred embodiment of the present invention, showing the valve connector in operation.

### DETAILED DESCRIPTION OF THE INVENTION

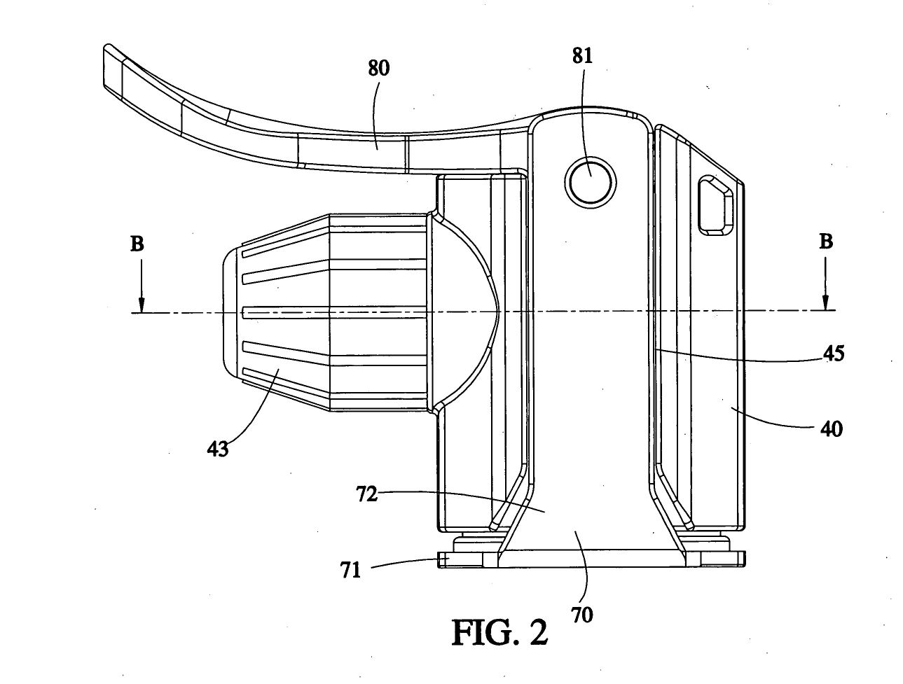

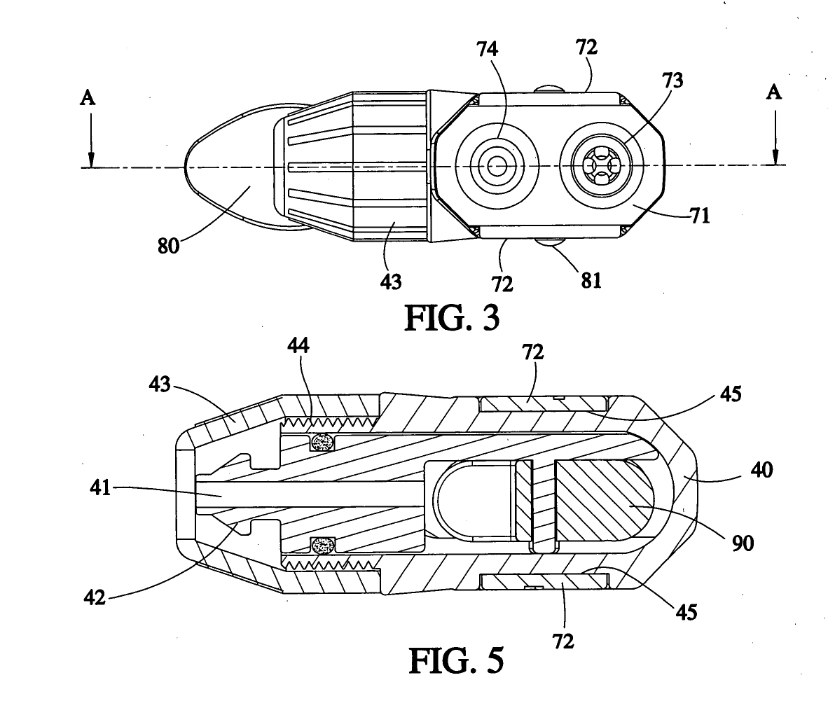

As shown in FIGS. 2 to 6, a valve connector of an air pump of the preferred embodiment of the present invention is a double-channel valve connector. In practice, the valve connector of the present invention may be a single-channel valve connector. The valve connector of the preferred embodiment comprises:

A case 40 has a channel 41 to be connected to a cylinder (not shown) of the air pump. In the present invention, the case 40 has a plug 42 communicated to the channel 41 to be inserted into a hose (not shown) and a cap 43 screwed to a thread 44 on the case 40. The case 40 may be incorporated in the air pump with hose, such as floor pump. The case 40 also may be connected to the air pump without the hose, such as head pump or mini pump.

Two connector assemblies 50 and 60 are provided in the case 40 and communicated with the channel 41. Each of the connector assemblies 50 and 60 has an elastic barrel 51 and 61 with a part extruded out of the case 40.

A pressing member 70 has a bottom 71 and two parallel arms 72 projected from the bottom 71. The case 40 is in between the arms 72 of the pressing member 70. The pressing member 70 has two bores 73 and 74 associated with the connector assemblies 50 and 60 respectively.

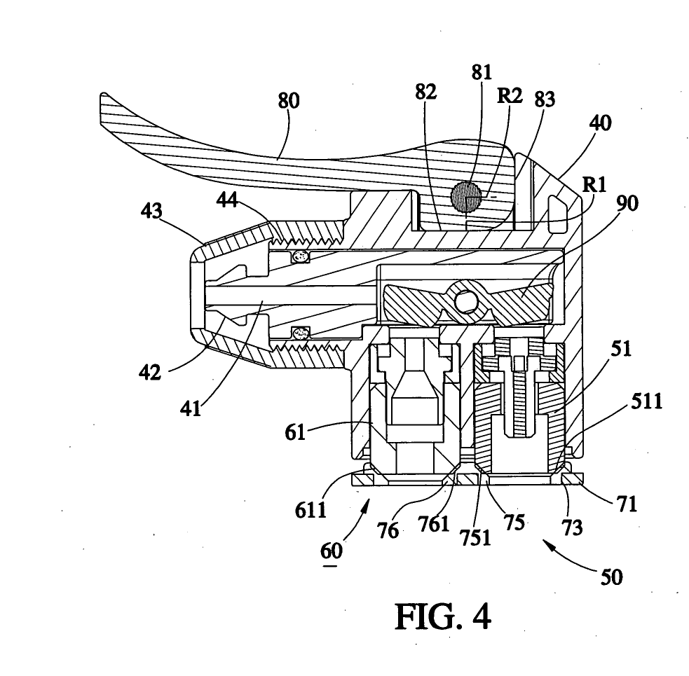

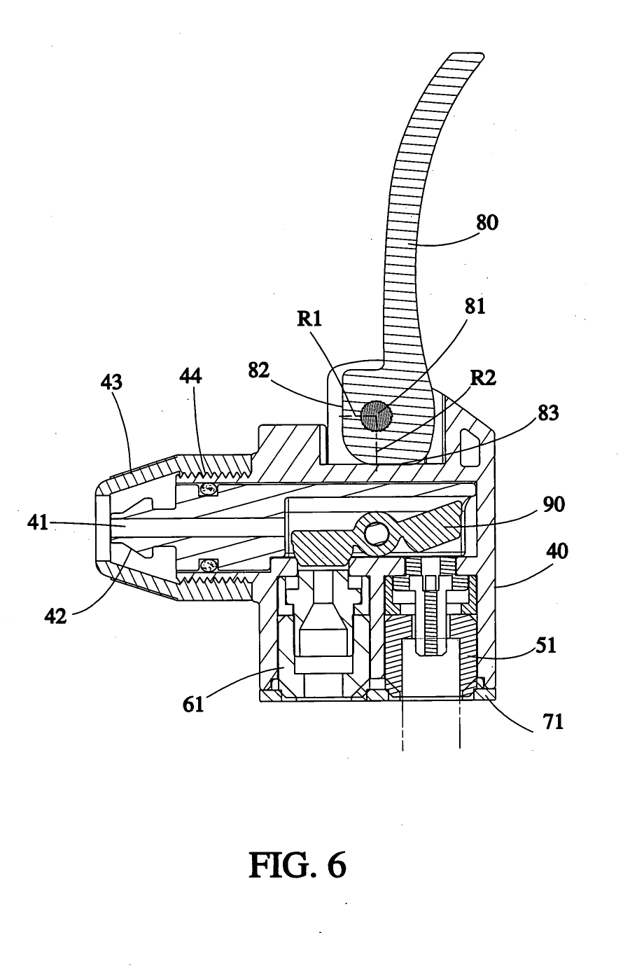

A lever 80 is pivoted on the pressing member 70 between the arms 72 by a pin 81. The lever 80 has a first cam portion 82 with a radius R1 from the pin 81 and a second cam portion 83 with a radius R2 from the pin 81, and R1 is less than R2. As a result, the elastic barrels 51 and 61 of the connector assemblies 50 and 60 are loosed when the lever 80 is moved with the first cam portion 82 pressing the case 40 to move the case 40 distal to the bottom 71 of the pressing member 70, as shown in FIG. 4. In this condition, valves (not shown) may be inserted into the elastic barrels 51 and 61. The elastic barrels 51 and 61 of the connector assemblies 50 and 60 are compressed when the lever 80 is moved with the second cam portion 83 pressing the case 40 to move the case 40 proximal to the bottom 71 of the pressing member 70, as shown in FIG. 6. In this condition, the valves are held in the elastic barrels 51 and 61.

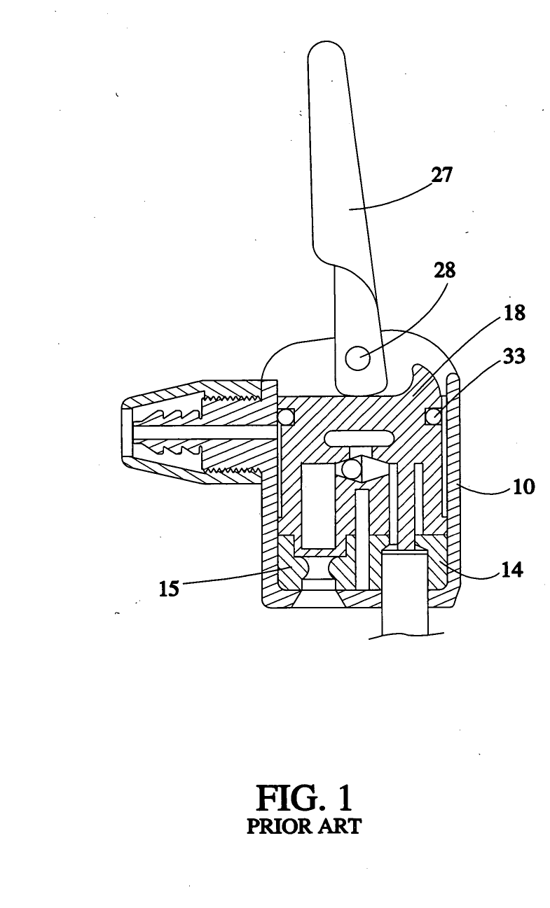

For accurate operation, the case 40 and the pressing member may be provided with a pair of rail and block or rib that may guide the movement of the case 40. In the present embodiment, the case 40 is provided with two slots 45, and the arms 72 of the pressing member 70 are received in the slots 45 respectively, as shown in FIG. 1 and FIG. 5, that may guide the relative movements of the pressing member 70 and the case 40 along the slots 45.

The valve connector of the present invention is provided with an auto-switching device 90 in the case 40 to switch channel 41 to communicate the connector assemblies 50 and 60. The auto-switching device 90 is a conventional device taught in the valve connector of FIG. 1.

To facilitate the assembly and guiding the direction of compressing the barrels, the pressing member 70 is provided with two guiding rings 75 and 76 in the bores 73 and 74. The guiding rings 75 and 76 have cone surfaces 751 and 761 mated with cone portions 511 and 611 of the elastic barrels 51 and 61.

The advantages of the present invention include an easier assembling way. The connector assemblies are inserted into slots in the case directly for positioning that is a faster assembling way than the conventional device. In addition, when moving the lever, the lever moves the case relative to the pressing member rather than compresses the elastic barrel directly that may have an accurate action without friction between the moving elements. The valve connector of the present invention needs less power to operate it than the conventional device.

What is claimed is:

1. A valve connector of an air pump, comprising:
a case having a channel therein;
at least a connector assembly provided in the case and communicated with the channel, wherein the connector assembly includes an elastic barrel;
a pressing member having a bottom and two arms projected from the bottom, wherein the case is received between the arms, and the bottom has a bore associated with the elastic barrel of the connector assembly; and
a lever, which is pivoted on the pressing member between the arms by a pin, having a first cam portion and a second cam potion, wherein a distance between the first cam portion and the pin is less than that between the second cam portion and the pin, whereby the elastic barrel is loosed when the lever is moved with the first cam portion pressing the case to move the case distal to the bottom of the pressing member, and the elastic barrel is compressed when the lever is moved with the second cam portion pressing the case to move the case proximal to the bottom of the pressing member.

2. The valve connector as defined in claim 1, wherein the case is provided with two slots to guide a movement of the pressing along the slots of the case.

3. The valve connector as defined in claim 2, wherein the arms of the pressing member are received in the slots respectively.

4. The air pump as defined in claim 1, further comprising a guiding ring received in the bore of the pressing member, wherein the guiding ring has a cone surface mated with a cone portion of the elastic barrel.
